(19) United States
(12) Patent Application Publication
(10) Pub. No.: US 2014/0016316 A1
(43) Pub. Date: Jan. 16, 2014

(54) ILLUMINANT DEVICE

(71) Applicant: Ting-Kuo HSIN, Taipei City (TW)

(72) Inventor: Ting-Kuo HSIN, Taipei City (TW)

(73) Assignee: Elementech International Co., Ltd.

(21) Appl. No.: 13/547,052

(22) Filed: Jul. 12, 2012

(51) Int. Cl. F21V 21/00; F21V 9/00

(52) U.S. Cl. 362/240; 362/249.02

(57) ABSTRACT

An illuminant device includes a housing and an illuminant unit. One side of the housing has a platform-part, the illuminant unit is disposed on the platform-part. The illuminant unit includes a carrying body and a plurality of light emitting diode (LED) dies. The carrying body is made of ceramic material and has three lateral surfaces adjoined with each other. Each lateral surface disposed with a plurality of circuit layouts, the LED dies are placed on the lateral surfaces and electrically connected to the circuit layouts.

### BACKGROUND OF THE INVENTION

1. Field of the Invention

The present invention relates to an illuminant device, especially to an illuminant device using light emitting diode as light source.

2. Description of Prior Art

Light emitting diodes (LEDs) have the advantages of small volume, long lifetime, difficulty damage, without mercury and lower power consumption. They are gradually replacing the fluorescent tubes and incandescent lamps and widely used in indoor and outdoor lighting and decorative lighting.

However, in comparison to other lighting source, LEDs with higher power are more prone to a problem of heat dissipation. The main reason is that the heat of the LEDs cannot be dissipated through infrared radiation. Moreover, the multiple packages of the LEDs render junction thermal resistances at different junctions such that the LEDs cannot effectively dissipate heat. In general, over-temperature operation makes the LEDs reduce light output (light decay), color shift and accelerate aging to shorten the lifetime of the LEDs.

In order to solve the problems mentioned above, some manufacturers increase the disposing amount of the cooling elements for rapid conducting heat generated by the LEDs, however, it makes the volume of the illuminant device increased. Some manufacturers use metal core printed circuit board (MCPCB) with metal core, such as aluminum, to carry the LEDs for rapidly conducting heat generated by the LEDs. Though the aluminum is a material with good thermal conductivity, an isolated layer is placed between circuit layouts and the metal core to prevent the circuit layouts and the metal core from conducting. The isolated layer with low thermal conductivity and heat conducting effect of the MCPCB is not good as expectation.

### SUMMARY OF THE INVENTION

It is an object of the present invention to provide an illuminant device. The illuminant device has a carrying body made of ceramic material for carrying light emitting diode (LED) dies, and LED dies are directly placed on the carrying body so as to prevent from junction thermal resistances. In addition, the carrying body can quickly conduct heat generated by the lighting LED dies because ceramic is a good thermal conductor.

Accordingly, the present invention provides an illuminant device. The illuminant device comprises a housing and an illuminant unit. One end of the housing comprises a platform-part, and the illuminant unit is disposed on the platform-part. The illuminant unit comprises a carrying body and a plurality of light emitting diode (LED) dies. The carrying body is made of ceramic material and has three lateral surfaces adjoined with each other. Each of the lateral surfaces is disposed with a plurality of circuit layouts. Each LED die is directly placed on the lateral surfaces and electrically connected to the circuit layouts.

The illuminant device according to the present invention directly placed the LED dies on the carrying body made of ceramic so as to prevent from junction thermal resistances, and the carrying body can quickly conduct heat generated by the lighting LED dies.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a perspective view of an illuminant device according to a first embodiment of the present invention.

FIG. 2 is a sectional view of the illuminant device according to the first embodiment of the present invention.

FIG. 3 is a partially sectional view of the illuminant unit according to the first embodiment of the present invention.

FIG. 4 is a partially sectional view of an illuminant unit according to a second embodiment of the present invention.

FIG. 5 is a perspective view of an illuminant device according to a second embodiment of the present invention.

FIG. 6 is a perspective view of an illuminant device according to a third embodiment of the present invention.

### DETAILED DESCRIPTION OF THE INVENTION

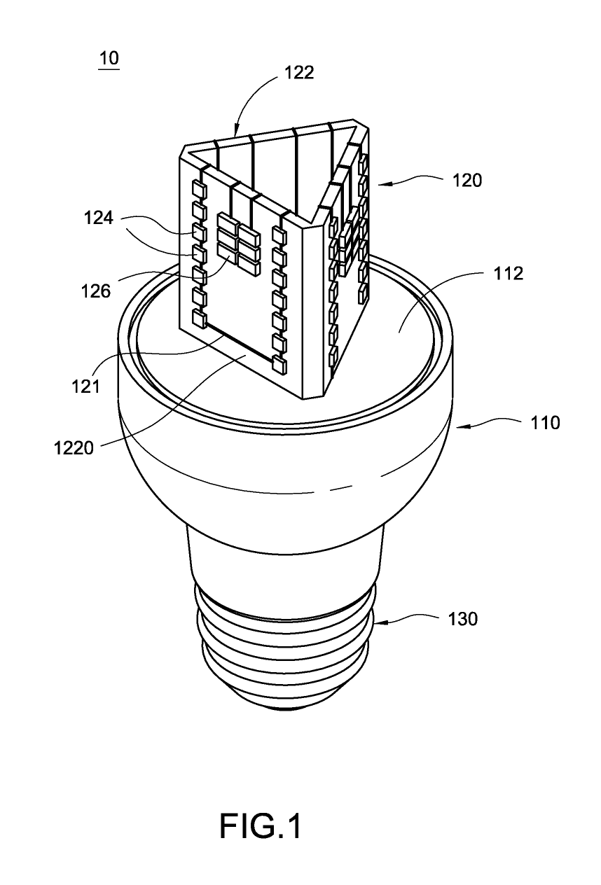

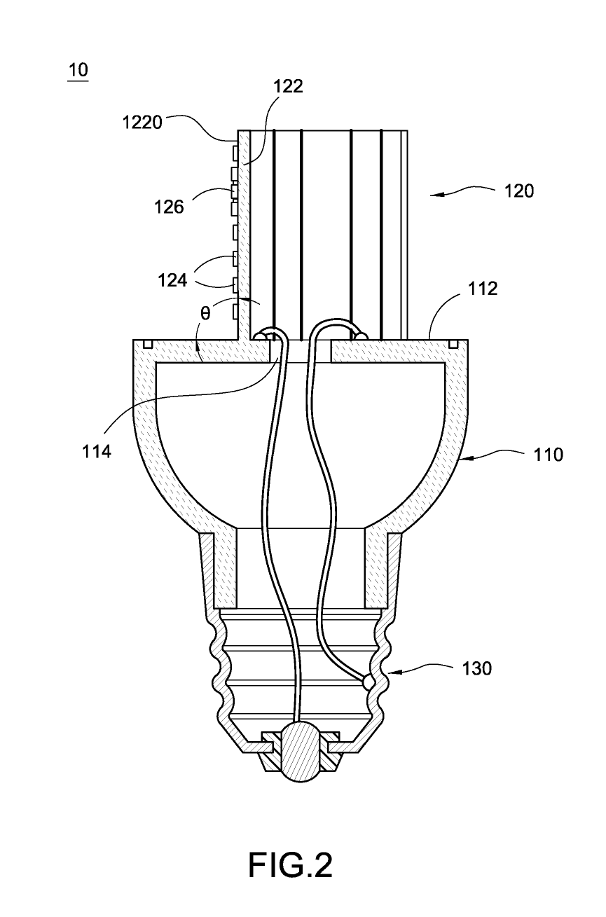

Reference will now be made in detail to the present embodiments of the invention, examples of which are illustrated in the accompanying drawings. Wherever possible, the same reference numbers are used in the drawings and the description to refer to the same or like parts. Referenced is made to FIG. 1 and FIG. 2, which are a perspective view and a sectional view of an illuminant device according to a first embodiment of the present invention. The illuminant device 10 includes a housing 110, an illuminant unit 120 and a conductive connector 130.

The house 110 is made of ceramic material by high temperature sintering and has advantages of high stability, high isolating property and high thermal conductivity. An end of the housing 110 has a platform-part 112. The platform-part 112 has a hole 114. In this embodiment, the hole 114 is formed on the center on the platform-part 112. The housing 110 further includes a plurality of fins (not shown) radially extended from an external surface thereof and used for effectively conducting heat generated by the illuminant unit 120. The fins and the housing 110 are preferably in one-piece form.

The illuminant unit 120 includes a carrying body 122, a plurality of light emitting diode (LED) dies 124 and a plurality of electrical elements 126. The LED dies 124 and the electrical elements 126 are respectively placed on the carrying body 122.

The carrying body 122 is made of ceramic material by high temperature sintering and has advantages of good isolating effect and thermal conductivity for quickly conducting heat generated by the LED dies 124 and the electrical element 126. In addition, the carrying body 122 and the housing 110 may be made of the same manufacturing material, or different manufacturing materials. In this embodiment, the carrying body 122 is made of the same manufacturing material as that of the housing 110, and the carrying body 122 and the housing 110 are preferably in one-piece form so as to effectively simplify manufacturing procedures and enhance the physical strength of the illuminant device 10.

In this embodiment, the carrying body 122 is in shape of triangle hollow pillar and has three lateral surfaces 1220 of rectangular shape. Each of the lateral surfaces 1220 is adjoined with each other. An included angle θ formed between each of the lateral surfaces 1220 and the platform-part 112 is 90 degrees. A plurality of circuit layouts 121 is placed on the lateral surfaces 1220. The circuit layouts 121 may be formed on the carrying body 122 by screen printing or cofiring.

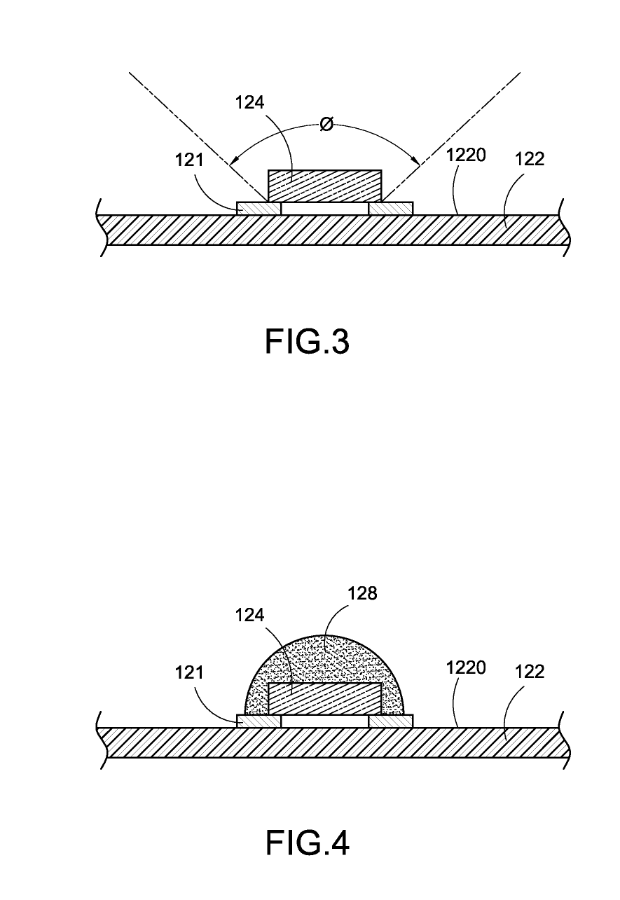

Referenced is made to FIG. 3, which is a partially sectional view of the illuminant unit according to the first embodiment of the present invention. Each of the LED dies 124 is directly placed on the lateral surfaces 1220 of the carrying body 122 and electrically connected to the circuit layouts 121. In this embodiment, the LED dies 124 are placed on the carrying body 122 by chip on board technology, and the illuminant angle φ of the LED dies 124 is larger than 160 degrees. The LED dies 124 may emit only one color and multiple colors. For the sake of convenient explain below, the LED dies 124 emit, for example, only one color, and the color is preferably blue.

With reference again to FIG. 1 and FIG. 2, the electrical elements 126 are placed on the carrying body 122 and electrically connected to the LED dies 124 through the circuit layouts 121. The electrical elements 126 may be constituted a circuit with function of rectification, driving or dimming for correspondingly controlling the illuminant condition of the illuminant device 10. In this embodiment, the electrical elements 126 are placed on the central of the lateral surfaces 1220, and the LED dies 124 surrounds the electrical elements 126 so as to prevent light emitting from the LED dies 124 from being blocked by the electrical elements 126.

The illuminant unit 120 further includes a wavelength converting layer 128. The wavelength converting layer 128 covers the LED dies 124, as shown in FIG. 4. The wavelength converting layer 128 is excited by partial blue light emitting by the LED dies 124 and generates a wavelength converting light. In this embodiment, the wavelength converting light is, but not limited to, yellow light. The wavelength converting light mixes with partially light emitting by the LED dies 124 to generate white light. The wavelength converting layer 128 may be phosphor or quantum dot phosphor.

With reference again to FIG. 1 and FIG. 2, the conducting connector 130 is connected to another end of the housing 110 and electrically connected to the illuminant unit 120 through a plurality of wires 140. The conducting connector 130 is adapted for screwing to a lamp holder (not shown) and for electrically connecting to an alternative current power. In this embodiment, one end of the wires 140 are electrically connected to the conducting connector 130, and another end thereof are electrically connected to the circuit layout 121 of the carrying body 122 through the hole 114.

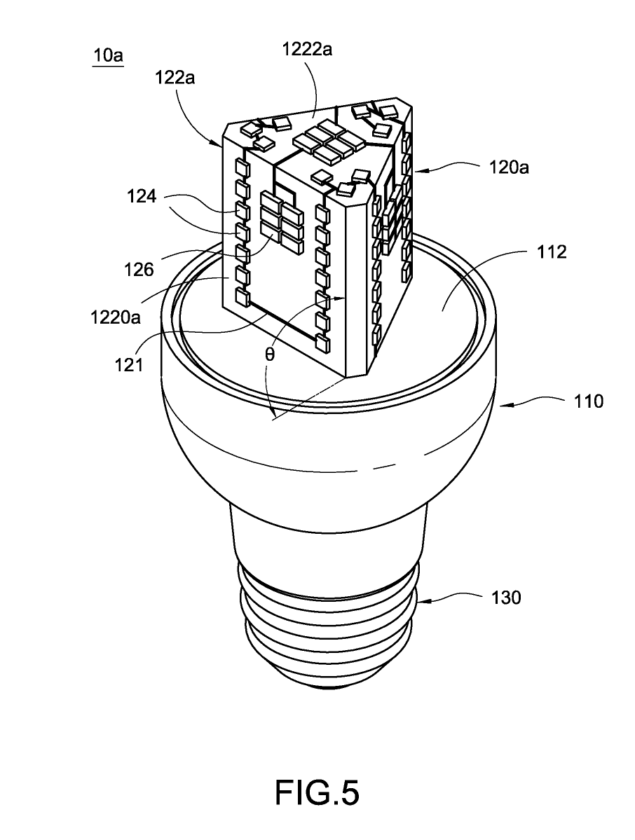

Reference is made to FIG. 5, which is a perspective view of an illuminant device according to a second embodiment of the present invention. The illuminant device 10a is similar to that of first embodiment mentioned above, and wherever possible, the same reference numbers are used in the drawings and the description to refer to the same parts. It should be noted that a carrying body 122a of an illuminant unit 120a shown in FIG. 5 is a solid-triangle pillar.

The carrying body 122a includes three lateral surfaces 1220a and a top surface 1222a. Each of the lateral surfaces 1220a is adjoined with each other and an included angle formed between the lateral surfaces 1220a is 120 degrees. An included angle formed between each of the lateral surfaces 1220a and the platform-part 112 is a right angle. The top surface 1222a is of triangle and adjoined to the lateral surfaces 1220a. A plurality of circuit layouts 121 are placed on the lateral surfaces 1220a and the top surface 1222a.

The LED dies 124 and the electrical elements 126 are respectively placed on the lateral surface 1220a and the top surface 1222a, and electrically connected with each other through the circuit layouts 121. As the result, the LED dies 124 placed on the lateral surfaces 1220a provide lateral light, and the LED dies 124 placed on the top surface 1222a provide forward light, thus the illuminant intensity of the illuminant device 10a is close to the conventional bulb lamp.

The function and relative description of other components of the illuminant device 10a is the same as that of first embodiment mentioned above and not repeat them here, and the illuminant device 10a can be achieved the functions as the illuminant device 10 does.

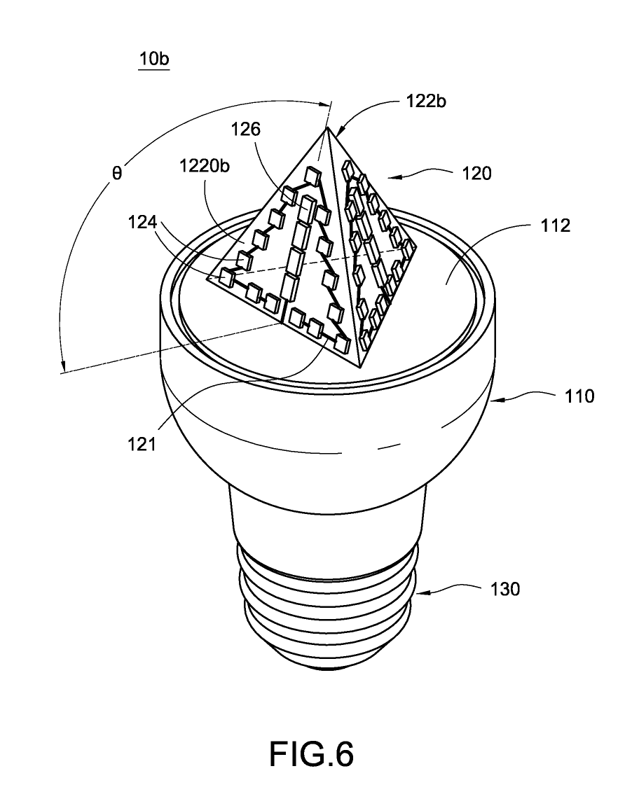

Reference is made to FIG. 6, which is a perspective view of an illuminant device according to a third embodiment of the present invention. The illuminant device 10b is similar to that of first embodiment mentioned above, and wherever possible, the same reference numbers are used in the drawings and the description to refer to the same parts. It should be noted that a carrying body 122b of an illuminant unit 120b shown in FIG. 6 is of pyramid.

The carrying body 122b includes three lateral surfaces 1220b. Each of the lateral surfaces 1220b is of triangle and adjoined with the other lateral surfaces 1220b, and an included angle 0 formed between each lateral surface 1220b and the platform-part 112 is an obtuse angle. A plurality of circuit layouts 121 is placed on the lateral surfaces 1220b.

The LED dies 124 and the electrical elements 126 are respectively placed on the lateral surfaces 1220b and electrically connected to the circuit layouts 121.

The function and relative description of other components of the illuminant device 10b is the same as that of first embodiment mentioned above and not repeat them here, and the illuminant device 10b can be achieved the functions as the illuminant device 10 does.

Although the present invention has been described with reference to the preferred embodiment thereof, it will be understood that the invention is not limited to the details thereof Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. An illuminant device comprising:
a housing comprising a platform-part;
an illuminant unit disposed on the platform-part, the illuminant unit comprising:
a carrying body made of ceramic material and comprising three lateral surfaces adjoined with each other, a plurality of circuit layouts being disposed on each lateral surface;
a plurality of light emitting diode (LED) dies, each LED die being directly disposed on the lateral surfaces and electrically connected to the circuit layouts; and
an conductive connector disposed on another side of the housing.

2. The illuminant device in claim 1, wherein the illuminant unit comprising a plurality of electrical elements, the electrical elements are respectively disposed on the lateral surfaces and electrically connected to the LED dies through the circuit layouts.

3. The illuminant device in claim 1, the housing is made of ceramic material.

4. The illuminant device in claim 3, wherein the housing and the carrying body are in one-piece form.

5. The illuminant device in claim 1, wherein each of the lateral surfaces is of rectangular shape and an included angle formed between each lateral surface and the platform-part is a right angle.

6. The illuminant device in claim 5, wherein the carrying body further comprises a top surface adjoined to the lateral surfaces.

7. The illuminant device in claim 1, wherein each of the lateral surfaces is of triangle shape, and an included angle formed between the each lateral surface and the platform-part is an obtuse angle.

8. The illuminant device in claim 1, wherein the illuminant unit further comprises a wavelength converting layer covering each of the LED dies.

9. The illuminant device in claim 1, further comprising a plurality of circuit layouts, one end of the circuit layouts are connected to the conductive connector and the another end of the circuit layouts connected to the circuit layouts through a hole of the platform-part for electrically connected to the conductive connector and the circuit layouts.

10. The illuminant device in claim 1, wherein the illuminant angle of the LED dies is larger than or equal to 160 degrees.
